(19) United States
(12) Patent Application Publication
(10) Pub. No.: US 2012/0098323 A1
(43) Pub. Date: Apr. 26, 2012

(54) PAD OF VEHICLE SEAT AND METHOD OF MANUFACTURING THE PAD

(75) Inventors: Kazutaka FUJIMOTO, Nagoya-shi (JP); Seiichi GOTOU, Nagoya-shi (JP)

(73) Assignee: TOYOTA BOSHOKU KABUSHIKI KAISHA, Aichi-ken (JP)

(21) Appl. No.: 13/272,845

(22) Filed: Oct. 13, 2011

(30) Foreign Application Priority Data
Oct. 25, 2010 (JP) 2010-238100

(51) Int. Cl. B60N 2/44; B60N 2/70; B29C 67/20; A47C 7/18

(52) U.S. Cl. 297/452.53; 264/46.7

(57) ABSTRACT

The present invention provides a pad of a vehicle seat that includes a foam, and an insert wire that is connected to an upholstery covering an outer surface of the foam, in which the insert wire is disposed within the foam in an elastically-deformed state. The present invention also provides a method of manufacturing a pad of a vehicle seat that includes a wire mounting process of mounting the insert wire within a mold where the insert wire is elastically deformed to a specified shape and mounted on a predetermined position; and a foam molding process of molding the foam, in which the insert wire elastically-deformed into the specified shape is disposed, by the mold.

### INCORPORATION BY REFERENCE

The disclosure of Japanese Patent Application No. 2010-238100 filed on Oct. 25, 2010 including the specification, drawings and abstract is incorporated herein by reference in its entirety.

### BACKGROUND OF THE INVENTION

1. Field of the Invention

The present invention relates to a pad of a vehicle seat where an insert wire to which seat upholstery (a cover) is attached is disposed within foam, and a method of manufacturing the pad.

2. Description of the Related Art

For example, as disclosed in Japanese Patent Application Publication No. 11-33248 (JP-A-11-33248), a pad is covered by upholstery that is a cover on a common vehicle seat. The upholstery is attached to the pad by using the insert wire (referred to as a drawing-in wire in JP-A-11-33248) that is disposed within the foam (a cushion material) forming the pad. Specifically, a suspending wire that is disposed on a back side of the upholstery and the insert wire that is disposed within the foam are bound (hog ring) at several points, and thus the upholstery is attached so as to cover the pad.

Generally, the insert wire has a different shape for each type of the vehicle seat. For example, the insert wire is designed in a shape based on a shape of the pad (foam), a shape of the upholstery, stitching positions of the upholstery, and the like. That is, different insert wires are usually prepared for different types of vehicle seats, and as the variety of seat shapes increases, the types of the insert wires also increase. Such the increase in the types of the insert wires leads to various problems such as the increase in manufacturing costs due to complication of wire bending, a mix-up due to the existence of the insert wires of similar shapes, and the increase in insert wire management costs for different types of the insert wires.

### SUMMARY OF THE INVENTION

In view of the situation with the related art described above, the present invention provides a pad of a vehicle seat that can reduce the increase in the types of the insert wire due to the increase in the variety of seat shapes, and a method of manufacturing the pad.

According to one aspect of the present invention, a pad of a vehicle seat that includes a foam, and an insert wire that is connected to an upholstery covering an outer surface of the foam, in which the insert wire is disposed within the foam in an elastically-deformed state is provided.

According to the pad of the vehicle seat as described above, because the insert wire is configured to be disposed within the foam in the elastically-deformed state, one type of the insert wire can be applied to various types of the pad of the vehicle seat. That is, even if the vehicle seat has different shapes and attachment shapes of the insert wire in the pad differs, when the deformed state is within an elastically-deformable range of the insert wire, one type of the insert wire can meet various types. Therefore, the increase in the types of the insert wire due to the increase in the variety of seat shapes can be reduced.

In the pad of the vehicle seat, it is preferable that the insert wire be disposed within a foam that constructs the pad of one vehicle seat in a first state, while disposed within a foam that constructs the pad of the other vehicle seat that is different from the one vehicle seat in a second state, and a not-elastically-deformed state of the insert wire be set between the first state and the second state.

According to the pad of the vehicle seat as described above, in the case that one type of the insert wire is applied to the vehicle seat where the attachment shape of the insert wire in the pad is in the first state and the other vehicle seat where the attachment shape is in the second state, when the not-deformed state of the insert wire is set between the first state and the second state, a deformation amount in elastic deformation of the insert wire can be reduced. That is, assembly of the insert wire (mounting to the mold that molds the foam) is made easily.

Here, in the pad of the vehicle seat, it is preferable that the not-elastically-deformed state of the insert wire be set in an intermediate position between the first state and the second state. When the insert wire is set in the intermediate position as described above, the deformation amount in the elastic deformation of the insert wire can be reduced more.

In the pad of the vehicle seat, when the insert wire in the not-elastically-deformed state is elastically deformed, there are preferably an elastically-deforming part and a not-elastically-deforming part, and a boundary between the parts is preferably curved in advance. According to such the structure, the insert wire can be elastically deformed at the curved part as a fulcrum, and the insert wire can be easily mounted on the mold.

In the pad of the vehicle seat, when the insert wire is elastically deformed, it is preferable that the insert wire be elastically deformed in a width direction or a forward and rearward direction of the pad, and it is also preferable that the insert wire be elastically deformed in a three-dimensional manner that is in the width direction and the forward and rearward direction of the pad.

According to the other aspect of the present invention, a method of manufacturing a pad of a vehicle seat that includes a foam and an insert wire that is connected to an upholstery covering an outer surface of the foam is provided. The method of manufacturing includes, a wire mounting process of mounting the insert wire within a mold where the insert wire is elastically deformed to a specified shape and mounted on a predetermined position, and a foam molding process of molding the foam, in which the insert wire is elastically-deformed into the specified shape is disposed, by the mold.

In accordance with the pad of the vehicle seat and the method of manufacturing the pad according to the present invention, because one type of the insert wire can be applied to various types of the pad of the vehicle seats, the increase in the types of the insert wire due to the increase in the variety of seat shapes can be reduced.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1A is a schematic view from the front of the pad of a vehicle seat according to an embodiment of the present invention (a first vehicle seat), in which the foam is shown with a thin dotted line and the insert wire that is disposed within the foam in the deformed state T1 is shown with a thick solid line, and the insert wire in the normal state N is shown with a thick dotted line;

FIG. 1B is a cross-sectional view that is taken along the line A-A of FIG. 1A (where hatching is omitted);

FIG. 2A is a schematic view from the front of the pad of a vehicle seat different from the vehicle seat shown in FIGS. 1A and 1B (a second vehicle seat), in which the foam is shown with a thin dotted line and the insert wire that is disposed within the foam in the deformed state T2 is shown with a thick solid line, and the insert wire in the normal state N is shown with a thick dotted line;

FIG. 2B is a cross-sectional view that is taken along the line B-B of FIG. 2A (where hatching is omitted);

FIG. 3 is a comparison view of the shapes of the insert wire in the normal state N, the deformed state T1, and the deformed state T2, in which the insert wire in the normal state N is shown with a dotted line, and the insert wires in the deformed states T1 and T2 are shown with solid lines;

FIG. 4 is a schematic view that simply shows the internal structure of a mold (only a half is shown) that forms the pad of the vehicle seat according to an embodiment of the present invention; and

FIG. 5 is a schematic view that illustrates the function of the pad of the vehicle seat according to an embodiment of the present invention, in which the cross-section of the pad and the upholstery over the pad of the vehicle seat (where hatching is omitted) are shown.

### DETAILED DESCRIPTION OF EMBODIMENTS

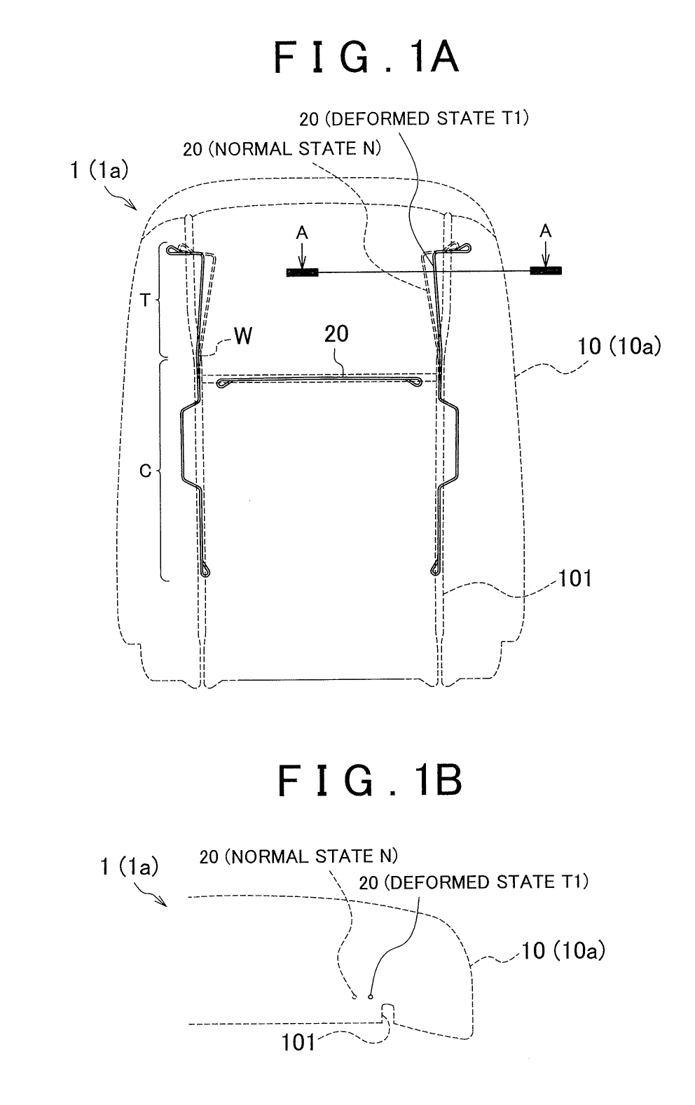

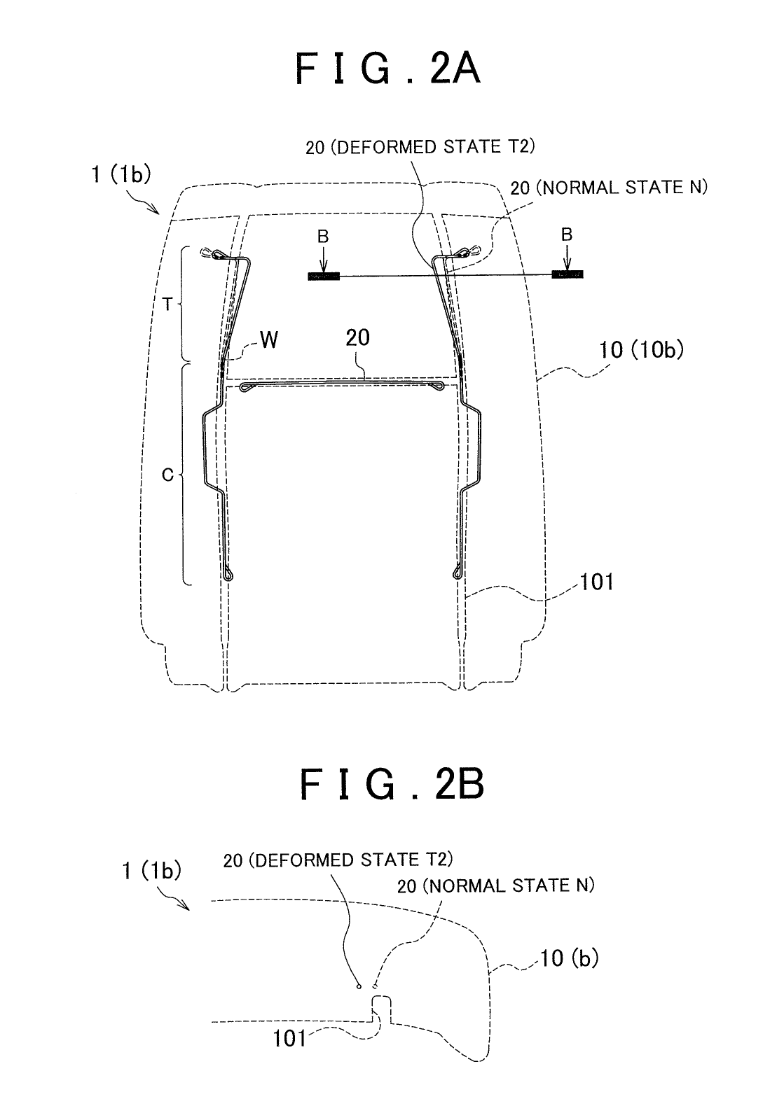

Hereinafter, one embodiment of the present invention will be described in detail with reference to the attached drawings. A vertical direction (height direction) in the following description denotes the height direction of the vehicle seat and the upward and downward direction in FIG. 1A and FIG. 2A. A width direction denotes the horizontal direction or the right and left direction in FIG. 1A and FIG. 2A. In addition, a forward direction denotes the side of a seating surface of the vehicle seat, and a rearward (backward) direction denotes the opposite side to the forward direction.

The pad 1 of the vehicle seat according to the present embodiment is used as a backrest part (seat back) for a person who sits on the vehicle seat, and the pad 1 includes a foam 10 and an insert wire 20 that is disposed within the foam 10. The foam 10 is a member that is used as a cushion material of the seat, and the foam 10 is formed in a specified shape by means of so-called foam molding. The insert wire 20 is formed by bending a linear metal material (such as iron) into a specified shape and disposed within the foam 10 by means of insert molding.

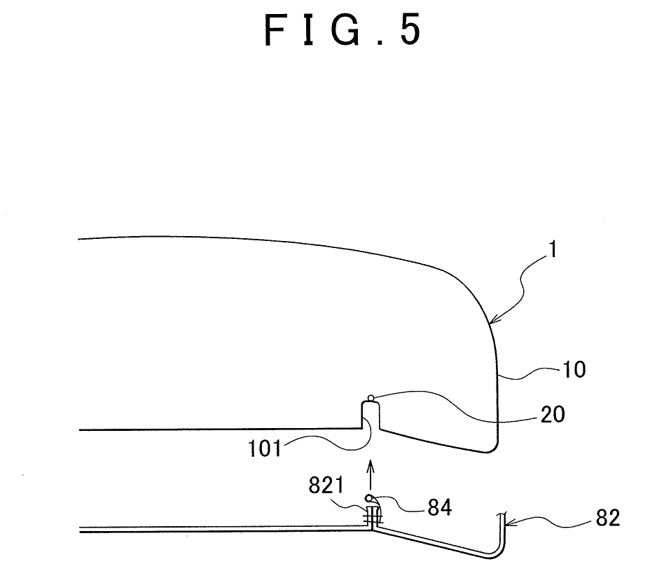

The insert wire 20 is used for attaching upholstery 82 that is a cover for covering the pad 1 of the vehicle seat. First, the function of the insert wire 20 is described with reference to FIG. 5. As shown in FIG. 5, a suspending wire 84 is mounted on the back side of the upholstery 82 so as to be placed along the insert wire 20. The suspending wire 84 and the insert wire 20 are bound (hog ring) at several points, and thus the outer surface of the pad 1 is covered by the upholstery 82. Generally, the upholstery 82 is formed by sewing multiple fabrics (leather). Therefore, the foam 10 is provided with a recess 101 so as to allow a stitching part 821 (a projecting part to the back side where multiple fabrics are overlapped) to escape. In many cases, the suspending wire 84 is mounted in the vicinity of such the stitching part 821, and therefore, the insert wire 20 along the suspending wire 84 is disposed in the vicinity of the recess 101 within the foam 10.

In the present embodiment, the insert wire 20 is disposed in the vicinity of the recess 101 of the foam 10. As shown in FIG. 1A, two insert wires 20 along the vertical direction and one insert wire 20 along the width direction are disposed in one pad 1 of the vehicle seat, and the shape in which the insert wires are disposed is in an approximately “H” shape as seen from the forward and the rearward directions.

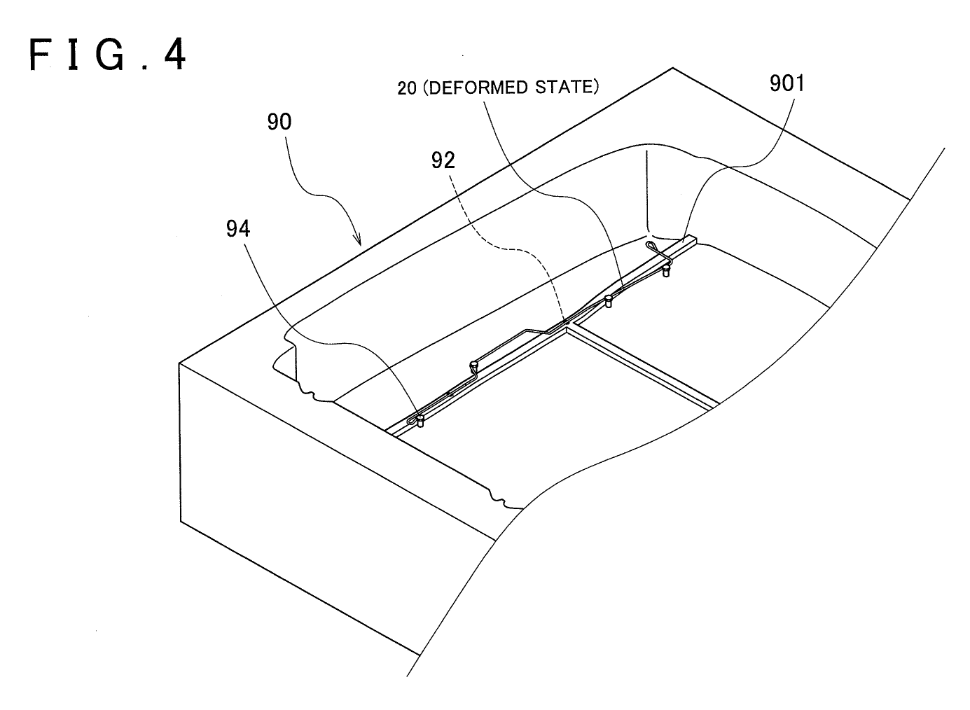

The insert wire 20 is disposed within the foam 10 in a state in which the wire is bent (plastically deformed) to a predetermined shape previously in an upstream process (wire bending process) and then elastically deformed to a specified shape. In other words, the shape of the insert wire 20 differs in the state in which the wire is not elastically deformed before the disposition within the foam 10 (hereinafter, the not-elastically-deformed state may be referred to as the normal state) and the state in which the wire is elastically deformed during the disposition within the foam 10 (hereinafter, the elastically-deformed state may be referred to as the deformed state). For example, in the structure shown in FIG. 1A, the insert wire 20 in the normal state N is disposed within the foam 10 along the vertical direction to be in the deformed state T1 in which the wire is elastically deformed. Although the details will be described later in the description of the method of manufacturing the pad 1 of the vehicle seat, the insert wire 20 is elastically deformed from the normal state N to the deformed state T1 when placed in a mold 90 through the use of positioning elements (a magnet 92 and a positioning pin 94) and the like that are disposed in the mold 90 that forms the foam 10 (see FIG. 4). In this state, the foam 10 is molded and maintains the deformed state T1 of the insert wire 20. In other words, the foam 10 has sufficient strength (hardness) for maintaining the deformed state T1 of the insert wire 20.

In the present embodiment, a deformation amount from the normal state N to the deformed state T1 or a deformed part is not limited specifically. The insert wire 20 may have such a structure that the deformed state T1 is in a range that allows the elastic deformation of the insert wire 20 in the normal state N and the deformed state T1 is maintained by the foam 10 that covers the insert wire 20.

As described above, when the insert wire 20 is configured to be disposed within the foam 10 in the elastically-deformed state, one type of the insert wire 20 can be applied to various types of the pad of the vehicle seat. Hereinafter, such the point will be described specifically. For example, it is hypothesized that the insert wire 20 is applied to one vehicle seat that is shown in FIGS. 1A and 1B (hereinafter, the vehicle seat may be referred to as a first vehicle seat in some cases) and the other vehicle seat that is different from the above one vehicle seat and that is shown in FIGS. 2A and 2B (hereinafter, the other vehicle seat may be referred to as a second vehicle seat in some cases). The first vehicle seat is designed such that the insert wire 20 is disposed within the foam 10a of the pad 1a in a first state, and the second vehicle seat is designed such that the insert wire 20 is disposed within the foam 10b of the pad 1b in a second state. In this case, if the insert wire 20 in the normal state N can be elastically deformed to the deformed state T1 that is the same as the first state and can be elastically deformed to the deformed state T2 that is the same as the second state, then the insert wire 20 can be applied to both of the first vehicle seat and the second vehicle seat.

In this case, it is preferable that the normal state N of the insert wire 20 be set between the first state (deformed state T1) and the second state (deformed state T2). In other words, it is preferable that the normal state N be on the path in the case where the insert wire 20 is deformed in the shortest distance between the first state and the second state. In the case of the structure shown in FIGS. 1A, 1B, 2A, 2B, and 3, when a part of a specified length from an upper end of the insert wire 20 in the normal state N is elastically deformed to an outer side in the width direction, the first state is obtained; and when a part of a specified length from an upper end is elastically deformed to an inner side in the width direction, the second state is obtained (where the part indicated with a symbol T in FIGS. 1A, 1B, 2A, 2B, and 3 is the elastically-deformed part.) When the insert wire is set as described above, the deformation amount from the normal state N to the deformed state T1 or T2 can be reduced.

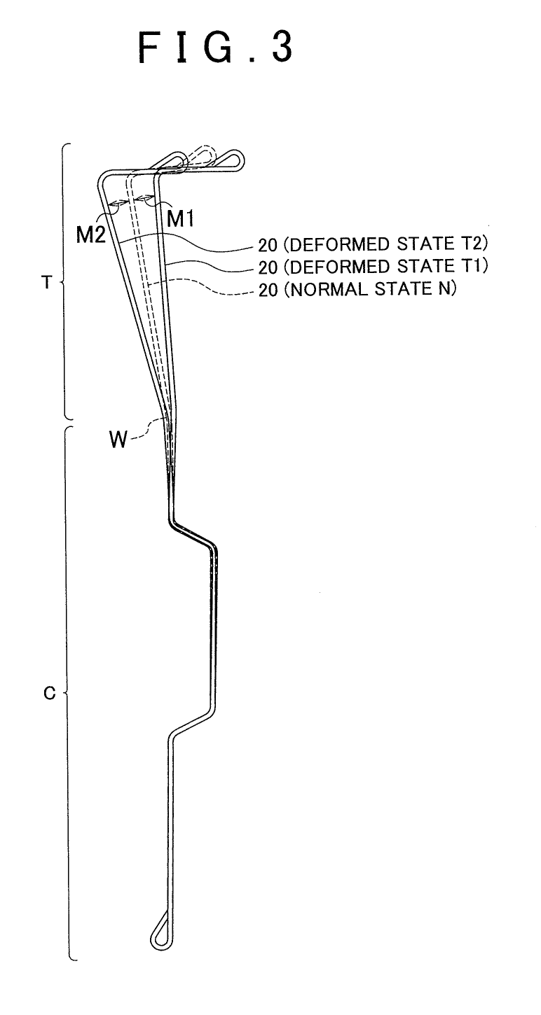

It is more preferable that the normal state N of the insert wire 20 be set in an intermediate position between the first state (deformed state T1) and the second state (deformed state T2). That is, as shown in FIG. 3, it is preferable that the deformation amount M1 from the normal state N and the deformed state T1 and the deformation amount M2 from the normal state N and the deformed state T2 be set approximately equal to each other. When the insert wire is set as described above, the deformation amount from the normal state N to the deformed state T1 or T2 can be reduced more. That is to say, because an imbalance in the deformation amount where one of “the deformation amount M1 from the normal state N to the deformed state T1” and “the deformation amount M2 from the normal state N to the deformed state T2” is greater than the other is not caused, the insert wire 20 can be easily elastically deformed to the predetermined shape even in the case of being applied to either of the first vehicle seat and the second vehicle seat.

In addition, one type of the insert wire 20 can be configured to be applied to not only the pads of two types of the vehicle seats such as the first and the second vehicle seats but also the pads of three or more types of the vehicle seats. In this case, it is preferable that the normal state N of the insert wire 20 be set between the deformed states of the insert wire 20 that is disposed within the foam 10 of the pad of each vehicle seat. It is more preferable that the deformation amounts from the normal state N to deformed states be set to be approximately constant in the state where the insert wire is three-dimensionally and elastically deformed.

As described above, when the insert wire is configured such that each deformed state is within an elastically-deformable range of the insert wire 20 in the normal state N and the insert wire 20 can be mounted on the mold 90 while maintaining the deformed state, one type of the insert wire 20 can meet the various needs having been satisfied by various types of the insert wire 20 that are disposed within the foam 10 of various types of the pad 1 of the vehicle seats.

As the structure that is described by using FIGS. 1A, 1B, 2A, 2B, and 3, it is preferable that at least a part of the normal state N and the deformed states be shared with one another (where the shapes are identical with one another) (the part indicated with a symbol C in FIGS. 1A, 1B, 2A, 2B, and 3 is the shared part.) In this case, the insert wire 20 can be elastically deformed relative to the shared part. More preferably, in the insert wire 20 in the normal state N which is bent in advance, a boundary between the shared part and non-shared part (a part where the shape changes in the normal state and the deformed state) may be curved in advance (where the part indicated with a symbol W in FIGS. 1A, 1B, 2A, 2B, and 3 is the curved part.) In such the structure, the insert wire 20 can be elastically deformed at the curved part as a fulcrum, and the insert wire 20 can be easily mounted on the mold 90.

A preferable example of the application of the present embodiment is the case where the seat shape may differ even in the same vehicle model due to the different grades or types, and therefore, attachment shapes of the insert wire 20 within the foam 10 may differ. In this case, the seat shapes are similar to one another, and therefore, there are many cases where the attachment shapes of the insert wire 20 are similar to one another (or have the similar shape with the shared part as described above.) In the above description, the structure as shown in FIGS. 1A and 1B is an example that is applied to the pad of a normal type vehicle seat in one vehicle model, and the structure as shown in FIGS. 2A and 2B is an example that is applied to the pad of a sports type vehicle seat in the same vehicle model as in FIG. 1.

The insert wire 20 that is disposed within the foam 10 is maintained in the elastically-deformed state (the deformed state T1 or the deformed state T2) by the foam 10. Thus, when the insert wire 20 is removed from the foam 10 of the pad 1 of the vehicle seat according to the present embodiment, the elastic deformation of the insert wire 20 is relieved.

Next, the method of manufacturing the pad 1 of the vehicle seat according to one embodiment of the present invention will be described. The method of manufacturing the pad 1 of the vehicle seat according to the present embodiment includes a “wire mounting process” and a “foam molding process”.

The “wire mounting process” is a process of mounting the insert wire 20 in the mold 90 that forms the vehicle seat. More specifically, the insert wire 20 in the normal state N which is bent to the specified shape previously in the upstream process (wire bending process) is elastically deformed to the specified shape (deformed state) to be mounted on the predetermined position. As shown in FIG. 4, the positioning elements such as the magnet 92 and the positioning pin 94 are disposed in the mold 90 (in a cavity), and the insert wire 20 is elastically deformed to the specified shape through the use of the positioning elements. As described above, the foam 10 is provided with the recess 101 so as to allow the stitching part 821 of the upholstery 82 to escape, and the insert wire 20 is disposed in the vicinity of the recess 101. Therefore, a projection 901 is formed in the mold 90 to mold the recess 101. The positioning elements are disposed in the vicinity of the projection 901. For example, the magnet 92 may be disposed inside the projection 901. The positioning elements are located to force the insert wire 20 to elastically deform to the specified shape. That is, when the insert wire 20 is mounted along the positioning elements that are disposed previously in the mold 90, the insert wire 20 takes the specified shape naturally and maintains the deformed state in the mold 90.

The “foam molding process” is a process of molding the foam 10 to the specified shape with the mold 90. The foam 10 is constructed by foam molding of a material such as urethane resin. When the foam 10 is molded, the insert wire 20 that is mounted within the mold 90 is covered by the foam 10 in the elastically-deformed state to the specified shape. After the molding, even if the foam 10 is removed from the mold 90 and the positioning elements that are disposed on the mold 90 do not act upon the insert wire 20, the deformed state of the insert wire 20 is maintained by the foam 10.

In accordance with the pad 1 of the vehicle seat and the method of manufacturing the pad 1 of the vehicle seat according to one embodiment of the present invention described above, the following effects can be obtained. In the present embodiment, since the insert wire 20 is configured to be disposed within the foam 10 in the elastically-deformed state, when the deformed state is within an elastically-deformable range of one type of the insert wire 20, the type of the insert wire 20 can be applied to various types of the pad 1 of the vehicle seats. Therefore, the increase in the types of the insert wire 20 due to the increase in the variety of seat shapes can be reduced. As a result, in the manufacturing of the pad 1 of the vehicle seat, the reduction of the manufacturing cost through the simplification of the wire bending in the upstream process the mix-up of the similar insert wire 20 (where providing identification markings to the similar insert wire 20 is unnecessary) can be prevented and the wire management costs for different types of the insert wires can be reduced by the decrease in the types of the insert wire 20.

In the case where the insert wire 20 is applied to the pad 1a of one vehicle seat and the pad 1b of the other vehicle seat that is different from the above one vehicle seat, since the normal state N before the insert wire 20 is elastically deformed is set between the first state (deformed state T1) and the second state (deformed state T2), the deformation amount in the elastic deformation of the insert wire 20 can be reduced. That is, the mounting of the insert wire 20 onto the mold 90 that molds the foam 10 (wire mounting process) can be easily made.

So far, although the embodiments of the present invention have been described in detail, the present invention is not limited to the embodiments described above. Various modifications are permissible without departing from the scope of the present invention.

For example, although the aforementioned embodiment has described the case where the insert wire 20 is elastically deformed in the width direction, the insert wire 20 may be configured to be elastically deformed in the forward and rearward direction. In addition, the insert wire 20 may be configured to be elastically deformed in both of the width direction and the forward and rearward direction, that is, in the three-dimensional manner.

Furthermore, although the pad 1 of the vehicle seat according to the aforementioned embodiment has been described as the backrest part (seat back) for a person who sits on the vehicle seat, the present invention may be applicable to a seating part (seat cushion).

The aforementioned embodiment has described in which the insert wire 20 is disposed in an approximately “H” shape; however, the layout of the wire may be properly changed. In addition, the aforementioned embodiment has described in which, the insert wire 20 along the vertical direction is disposed within the foam 10 in the elastically-deformed state. However, the present invention is not limited to this. For example, the insert wire 20 along the width direction as shown in the aforementioned embodiment may be disposed within the foam 10 in the elastically-deformed state.

While the invention has been described with reference to example embodiments thereof, it is to be understood that the invention is not limited to the example described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

What is claimed is:

1. A pad of a vehicle seat, comprising:
a foam; and
an insert wire that is connected to an upholstery covering an outer surface of the foam, wherein
the insert wire is disposed within the foam in an elastically-deformed state.

2. The pad of a vehicle seat according to claim 1, wherein
the insert wire is disposed within a foam that constructs the pad of one vehicle seat in a first state, while disposed within a foam that constructs the pad of another vehicle seat that is different from the one vehicle seat in a second state, and
a not-elastically-deformed state of the insert wire is set between the first state and the second state.

3. The pad of a vehicle seat according to claim 2, wherein
the not-elastically-deformed state of the insert wire is set in an intermediate position between the first state and the second state.

4. The pad of a vehicle seat according to claim 2, wherein
in the insert wire in the not-elastically-deformed state, when the insert wire is elastically deformed, there are an elastically-deforming part and a not-elastically-deforming part, and a boundary between the parts is curved in advance.

5. The pad of a vehicle seat according to claim 1, wherein
when the insert wire is elastically deformed, the insert wire is elastically deformed in a width direction of the pad.

6. The pad of a vehicle seat according to claim 1, wherein
when the insert wire is elastically deformed, the insert wire is elastically deformed in a forward and rearward direction of the pad.

7. The pad of a vehicle seat according to claim 1, wherein
when the insert wire is elastically deformed, the insert wire is elastically deformed in a three-dimensional manner that is in the width direction and the forward and rearward direction of the pad.

8. A method of manufacturing a pad of a vehicle seat that includes a foam and an insert wire that is connected to an upholstery covering an outer surface of the foam, comprising:
a wire mounting process of mounting the insert wire within a mold while the insert wire is elastically deformed to a specified shape and mounted on a predetermined position; and
a foam molding process of molding the foam, in which the insert wire is elastically-deformed into the specified shape is disposed, by the mold.
